(19) United States
(12) Patent Application Publication
(10) Pub. No.: US 2011/0266393 A1
(43) Pub. Date: Nov. 3, 2011

(54) METHOD AND DEVICE FOR EXTERNAL DE-ICING OF AIRCRAFT

(76) Inventor: Marc Liczbinski, Seeheim-Jugenheim (DE)

(21) Appl. No.: 13/143,091

(22) PCT Filed: Dec. 2, 2009
(86) PCT No.: PCT/EP2009/008567

§ 371 Date: Jul. 1, 2011

(30) Foreign Application Priority Data
Jan. 5, 2009 (DE) 10 2009 004 124.9

(51) Int. Cl. B64D 15/04

(52) U.S. Cl. 244/134 C

(57) ABSTRACT

In a method for exterior de-icing of an aircraft before takeoff, a region of the aircraft to be de-iced has hot air applied thereto and is heated, the air exiting a de-icing nozzle that can be disposed in the vicinity of the region to be de-iced, hot air exiting a hot air outlet opening of the aircraft is collected and fed to the de-icing nozzle. A device for externally de-icing aircraft, having a flexible hot air channel and a de-icing nozzle disposed at a first end of the hot air channel includes a collector device for hot air exiting the aircraft and connected to a second end of the hot air channel.

### BACKGROUND AND SUMMARY

The invention relates, according to an aspect thereof, to a method for the exterior deicing of airplanes before a start, whereby an area of the airplane to be deiced has hot air applied to it and is heated, which hot air exits from a deicing nozzle that can be arranged in the vicinity of the area to be deiced.

Cool and in particular moist winter weather conditions can have the result that exposed airplane surfaces such as the fuselage, the carrying surfaces, the tail unit or the engine intake ice over. The ice layer, which is often irregularly formed and/or thick, can among other things, adversely affect the ability of movable parts to function or the aerodynamic qualities of the airplane and result in endangering the operation of the airplane.

In order to be able to ensure the safety and a smooth operating sequence during the flight, the exposed surfaces of an airplane that are affected by an icing can be deiced before its start, depending of the weather conditions and the ice formation, and be freed of problematic ice deposits.

Stationarily arranged deicing apparatuses for airplanes are described, for example, in U.S. Pat. No. 5,458,399 A or U.S. Pat. No. 6,616,102 B1. These and other stationarily arranged deicing apparatuses known from practice customarily have movable booms and spray nozzles fastened to them by means of which a liquid deicing agent can be sprayed on the iced areas of the airplane. Stationary deicing apparatuses, so-called gantries, have not been accepted in practice for various reasons.

In publication JP 03 287 497 A, starting from a heat source arranged in the interior of the airplane, the heat produced in this heat source is transferred via suitable heat transmission apparatuses such as, for example, “heat pipes” to the outer skin of the airplane to be deiced. Such deicing apparatuses have a very complex and expensive construction and can only be operated with a significant expenditure of energy on account of the heat transfer, that is necessarily associated with losses.

It is known from practice that areas which are readily accessible from the outside and in particular the turbine blades at the engine intake can be deiced with a movable air-conditioning apparatus. The air-conditioning apparatus, that is usually arranged on a motor vehicle or on a trailer, is provided for the exteriorly supported air-conditioning of the airplane cabin in order to perform an air-conditioning of the airplane independently of the operation or the non-availability of an auxiliary unit (APU) on board. The air-conditioning apparatus generates fairly large amounts of optionally air-conditioned hot air that exits with the aid of a blower from a hose end and can be fed into the on-board air-conditioning apparatus. However, such air-conditioning apparatuses are only used in exceptional cases since as a rule the on-board auxiliary unit is provided for and suitable for the air-conditioning of the vehicle on the ground.

If the hose end is not connected to the intake opening for air-conditioned air to the airplane but rather is held above the areas to be deiced, the ice layer located there is melted off and removed by the exiting hot air. However, since such movable air-conditioning apparatuses are not provided for deicing airplanes, these apparatuses are not suited in an unlimited manner for the deicing of airplanes and their use for this purposes is associated with disadvantages.

Instead of the movable air-conditioning apparatus, mobile deicing apparatuses specially provided for this purpose of use are used. In this instance an apparatus for generating hot air or for spraying a liquid deicing agent is usually mounted on a vehicle. The hot air generated with the apparatus can be blown through a deicing nozzle onto the areas of the airplane to be deiced in order to warm them up and to melt off ice deposits. Such mobile deicing apparatuses are known, for example, from EP 0 95 481 B1 or U.S. Pat. No. 6,045,902 C1.

However, liquid deicing agents are not suitable for a deicing of engine intakes since a contamination of the engine interior and of the bleed air system can not be excluded. For this reason engine intakes and in particular the turbine blades are freed of ice and snow with mechanical means such as, for example, hot air or, however, with brooms. The deicing of engine intakes is therefore especially expensive and time-intensive.

Other disadvantages of such mobile deicing apparatuses known from practice are the high costs for acquisition and operation, that regularly have the consequence that the number of available deicing apparatuses is less than the need for deicing apparatuses under corresponding weather conditions. Since experience has shown that a formation of ice on airplanes that makes their deicing necessary only occurs several weeks in the year, the mobile deicing apparatuses known from practice must be stored for the rest of the time and maintained in a state ready for operation and be appropriately serviced. However, if deicings are required, deicing apparatuses are then needed in the greatest possible number and should make a reliable deicing possible in the shortest possible time.

Accordingly, the present invention has, according to an aspect thereof, the problem of developing a method for the exterior deicing of airplanes that makes possible a rapid and reliable deicing of the airplane immediately before start without apparatuses that are expensive to construct and without a high energy consumption or high operating costs becoming necessary.

This problem is solved in accordance with an aspect of the invention in that hot air exiting from an opening of the airplane is collected and supplied to the deicing nozzle.

In most instances the supplying of energy for the airplane is assumed by on-board energy sources or energy converters a rather long time before the start of the airplane already. To this end, for example, an auxiliary engine (APU) of the airplane is also operated during its standstill and electricity, hot air and compressed air are produced by a turbine and made available for distribution and usage in the airplane. The hot air, which is often compressed and heated and that flows out of the auxiliary engine is also designated as bleed air. This bleed air can be used, after a suitable cooling, for the air-conditioning of the airplane cabin on the ground. During the flight the bleed air serves for the thermal deicing of engine intakes and front edges of wings as well as for the air-conditioning and pressure-loading of the airplane cabin during the flight. The non-utilized component of the heated waste air generated during the operation of the APU is removed.

The hot air used for the air-conditioning of the inner space of the airplane is cooled down by a regulated admixing of cool outer air or customarily by heat exchangers around which ambient air flows which is drawn in and subsequently removed again. This drawn-in ambient air, that is heated by the heat exchangers around which it flows and subsequently flows out of the airplane again from a hot-air discharge opening, can also be designated as ram air.

Most airplanes comprise hot-air discharge openings on a lower side of the fuselage from which openings the ram air, which is often heated to approximately 80° C. to 100° C. exits and that can therefore also be designated as ram-air outlet flaps.

The invention is based, according to an aspect thereof, on the idea of making useful and using this hot air, which exits from the airplane at least before the start and which has previously not been further used, for the deicing of the airplane and in particular for the deicing of the engine intakes. The hot air, which regularly exits with a sufficient flow rate, must merely be collected and conducted by a hot-air conduit that ends in a deicing nozzle to the surfaces to be deiced. The use of exterior heat production apparatuses or rather large amounts of liquid deicing agent is not necessary. A method in accordance with an aspect of the invention can be carried out with low cost and without greater constructive expense and therefore makes a reliable and rapid deicing possible in case of need so that in the case of corresponding weather conditions merely a slight adverse affect of the flight operation has to be accepted to the extent that such adverse effects can basically not even be avoided.

The hot air used for the deicing can stem from any hot-air exit opening of the airplane, so that discharged bleed air as well as ram air or other hot-air sources of the airplane could also be used. However, it is preferably provided that the hot air exiting from a ram-air discharge opening is supplied to the deicing nozzle. In most airplane types ram air heated to approximately 80° C. to 100° C. is available in a sufficient amount. Since the ram air is customarily used for temperature regulation and air-conditioning of the airplane cabin and therefore often has regulated temperature qualities and flow qualities for this reason and this purpose, a self-regulating effect which develops can be utilized in an advantageous manner in a subsequent further use of the ram air exiting with regulated qualities. If, for example, the flow rate of the hot air exiting from the ram-air discharge opening would be noticeably reduced on account of a flow resistance and the temperature conditions and pressure conditions of the ram air would change in the area around the heat exchangers arranged in the airplane interior by the backup conditioned by this, then the amount and the flow rate of the ram air drawn in from the environment would be correspondingly adapted in order to be able to ensure a sufficient cooling of the heat exchangers at all times. Adverse effects due to the subsequent further using of the exiting hot air for purposes of deicing would be partially or completely compensated in this manner. A separate conducting of the flow or regulation of the temperature of the exiting hot air or ram air therefore does not appear to be obligatorily necessary.

However, in order to be largely independent of the qualities of the exiting hot air, it can be advantageous if the temperature of the hot air exiting from the deicing nozzle can be changed. In order to avoid endangering the operating personnel or a damaging of the outer surface of the airplane to be deiced, the hot air exiting from the discharge opening of the airplane can be cooled, for example, by the admixture of cold ambient air. The admixing of cool ambient air can be set manually or automatically with the aid of a regulating circuit.

For the same reason, it can be advantageous if the flow rate of the hot air can be varied on the path to the deicing nozzle. In particular when using a long hose or a flexible hot-air conduit, a sufficiently high and if necessary a given flow rate of the hot air exiting from the deicing nozzle can be made possible with simple means by a suitable blower or ventilator, in particular in the vicinity of the deicing nozzle.

The invention also relates, according to an aspect thereof, to an apparatus for the exterior deicing of airplanes before a start, with a flexible hot-air conduit and a deicing nozzle arranged on a first end of the hot-air conduit.

The invention, according to an aspect thereof, provides that the apparatus comprises a collector apparatus for hot air exiting from the airplane, which collector apparatus is connected to a second end of the hot-air conduit. The collector apparatus can be substantially designed to be closed on all sides and comprises only one entrance opening for the hot air exiting from the airplane and comprises a connection to the end of the hot-air conduit fastened to it.

The entrance opening is advantageously adapted to the dimensions of the hot-air discharge opening of the airplane from which the hot air used for the deicing exits from the airplane. The flexible hot-air conduit can be, for example, a sufficiently temperature-resistant hot-air hose. The length of the flexible hot-air conduit is advantageously adapted to the maximal distance of the airplane areas to be deiced from the particular used hot-air discharge opening of the airplane.

An embodiment of the concept of an aspect of the invention provides that the collector apparatus comprises a housing with an entrance opening, whereby the housing, surrounding a hot-air exit opening, can be fixed on an outer wall of the airplane. To this end the collector apparatus can be approached, for example, from the outside to the outer wall of the airplane and pressed against it and fixed in this position in order to receive the hot air exiting from the hot-air discharge opening as efficiently and completely as possible with the collector apparatus and in order to be able to supply it to the hot-air conduit. However, it is also conceivable to form and place suitable fastening apparatuses on the outer wall of the airplane in the area around the hot-air discharge opening to be used for the most air-tight fastening possible of the collector apparatus. The entrance opening of the collector apparatus can also be adapted in such a manner to the hot-air discharge opening of the outer wall of the airplane that the entrance opening comprises outwardly projecting catch hooks or the like that surround an edge of the hot-air discharge opening of the airplane and make possible a positive connection of the collector apparatus to the hot-air discharge opening and to the surrounding outer wall of the airplane.

In order to avoid damage to the outer wall of the airplane during the positioning and arranging of the collector apparatus on the outer wall of the airplane and to make possible at the same time a better seal of the collector apparatus to possibly curved surfaces of the outer wall of the airplane in the area around the hot-air discharge opening, it is provided that the collector apparatus comprises sealing means arranged around the entrance opening on a side facing the outer wall of the airplane. In most instances an elastic sealing lip or a rubber bead surrounding the entrance opening should already suffice for being able to ensure a seal that is sufficient in practice and at the same time to make possible a sufficient adaptation of the collector apparatus to the outer wall of the airplane even in different airplane types.

In order to make possible an adaptation of the entrance opening to different hot-air discharge openings in different airplane types, it is provided that a cross-sectional surface of the entrance opening can be varied.

It is preferably provided to this end that an adapter apparatus that changes the cross-sectional surface of the entrance opening can be attached to the entrance opening. An adaptation of the entrance opening of the collector apparatus, which adaptation is economical and can be manipulated in a simple and quick manner, to differently designed hot-air discharge openings of different airplane types can be performed with the adapter apparatus in each individual instance.

The adapter apparatus can be, for example, a funnel-shaped attachment and can be connected in a clamping or engaging manner in the area of the entrance opening to the housing of the collector apparatus. The entrance opening is advantageously arranged on an upper side of the housing of the collector apparatus in order to be able to be approached from below to the hot-air discharge opening, that is customarily located on the bottom side of the airplane fuselage, and to be tightly pressed against the airplane fuselage. It should be sufficient in most instances if a funnel-shaped attachment is placed from above onto the entrance opening of the housing and is fixed in a clamping manner to the housing. As a result of the intrinsic weight of the funnel-shaped attachment, the latter is pressed onto the housing and retained in the entrance opening.

The funnel-shaped attachment can additionally comprise fastening elements or catch elements that prevent an unintended loosening of the funnel-shaped attachment from the housing during operation.

The funnel-shaped attachment can also comprise sealing means arranged around the entrance opening of the funnel-shaped attachment on a side facing the outer wall of the airplane.

It is also conceivable that the entrance opening can be varied by a pivotably supported flap. The pivotably supported flap can be moved as desired between a through position that completely opens the entrance opening and between a closed position that completely covers the entrance opening.

According to an especially advantageous embodiment of the concept of an aspect of the invention it is provided that the pivotably supported flap can be moved counter to a return force from a closed position into a partially or completely open position. The return force can be produced, for example, by suitably arranged traction springs or pressure springs or, however, by a cable traction mechanism and by weights fastened to it.

In order to be able to influence the temperature of the hot air exiting from the deicing nozzle of the apparatus, it is provided that the collector apparatus or the hot-air conduit comprises closable openings for the admixture of cool outside air. The closable openings can be designed to be manually actuated or actuated automatically in order to make possible a controlled or regulated admixture of cool outside air. The apparatus can comprise a temperature sensor or a temperature display in order to make possible an admixture of cool outside air that is controlled or regulated by a user or automatically and to set the temperature of the hot air exiting from the deicing nozzle in this manner.

In order to be able to regulate the flow rate and/or the throughput of the hot air exiting from the deicing nozzle, it is provided that the apparatus comprises at least one apparatus for the generation of flow. Suitable apparatuses for the generation of flow can be, for example, ventilators or blowers that are preferably arranged in the area of the collector apparatus or of the deicing nozzle and support, maintain or reinforce the flow of hot air in the hot-air conduit in particular when using long hot-air conduits. In order to be able to also bring about a reduction of the flow rate of the hot air exiting from the deicing nozzle, additional flow obstacles such as, for example, inwardly projecting lamellas can be present that can be moved or pivoted if required and that reduce the flow rate of the hot air in the hot-air conduit.

According to an embodiment of the inventive concept it is provided that the collector apparatus is supported in a height-adjustable manner on a movable frame. The apparatus for the exterior deicing of airplanes can be moved to the airplane to be deiced either manually or by a pulling vehicle and positioned in the area of the hot-air discharge opening. The collector apparatus can be moved to the hot-air discharge opening by a suitable height-adjusting mechanism such as, for example, an extensible telescopic rod and be located or fixed close to the surrounding outer wall of the airplane. The height-adjusting mechanism as well as the movable frame can be designed to be moved manually or in an automated or self-acting manner.

### BRIEF DESCRIPTION OF THE DRAWINGS

Exemplary embodiments of the concept of an aspect of the invention are explained in detail in the following and are shown in the drawings, in which:

FIG. 1 shows a schematic lateral view of an apparatus for the exterior deicing of an airplane,

FIG. 2 shows a lateral view of the apparatus in accordance with FIG. 1, whereby an engine intake to be deiced is schematically shown in addition,

FIG. 3 shows a schematic view in section of the apparatus shown in FIG. 2 in an enlarged view,

FIG. 4 shows a sectional view according to FIG. 3, whereby a slightly modified apparatus for deicing is shown, and

FIG. 5 shows a lateral view of an device according to FIG. 1 provided with an additional adapter apparatus.

### DETAILED DESCRIPTION

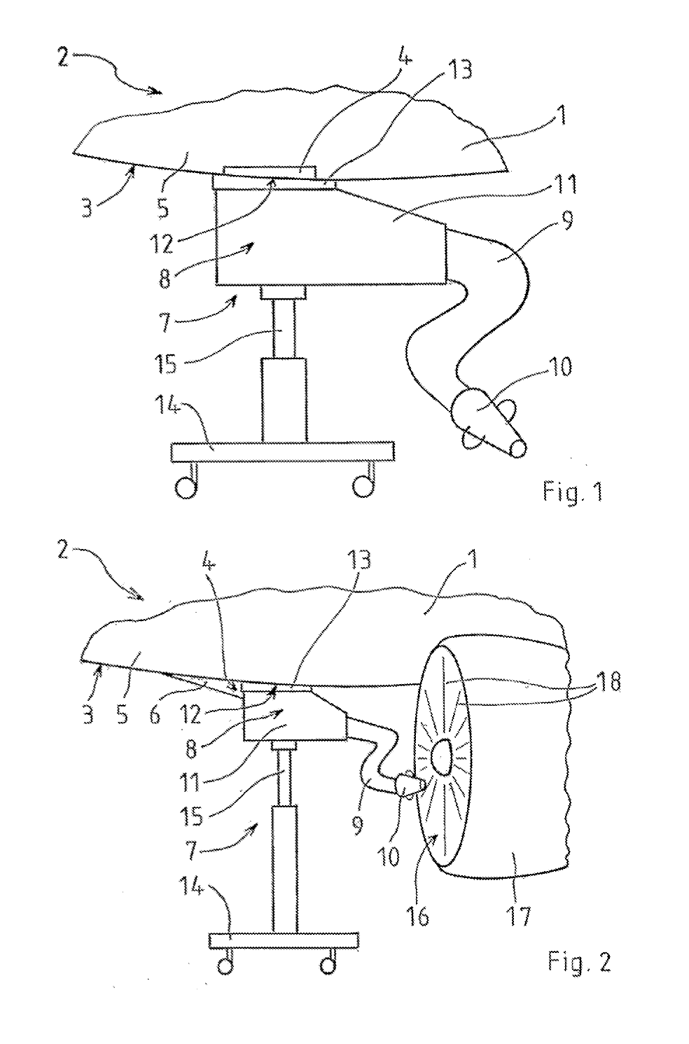

FIGS. 1 to 5 shows a section of an airplane fuselage 1 of an airplane 2. A hot-air discharge opening 4 is located on the bottom 3 of airplane fuselage 1. Whereas the hot-air discharge opening 4 in the exemplary embodiment shown in FIG. 1 has only one opening running flush with bottom 3 in an outer skin 5 of airplane 2, the hot-air discharge opening 4 shown in FIGS. 2 to 4 is closed with a pivotably supported discharge opening flap 6 which hot-air discharge opening 4 partially or completely frees during operation.

The ambient air which is drawn in and subsequently blown out again can be designated as ram air. The hot-air discharge openings shown in FIGS. 1 to 4 are discharge openings for ram air that are arranged in many airplane types on bottom 3 of airplane fuselage 1 and from which the ambient air necessary for the air-conditioning of an airplane cabin, which air is drawn in at another location, is blown out again. In the exemplary embodiment shown in FIGS. 2 to 4 the hot-air discharge opening 4 has a so-called ram-air outlet flap.

An apparatus 7 for the exterior deicing of airplanes comprises a collector apparatus 8 for the ram air exiting from hot-air discharge opening 4. A flexible hot-air conduit 9 is connected to collector apparatus 8, which conduit comprises or consists in the exemplary embodiments shown of a sufficiently temperature-resistant, flexible hose. ,Flexible hot-air conduit 9 empties into a deicing nozzle 10 from which the hot air trapped by collector apparatus 8 and conducted through hot-air conduit 9 can flow out directed onto the areas of airplane 2 to be deiced.

Collector apparatus 8 comprises in the exemplary embodiment schematically shown in FIG. 1 a housing 11 substantially closed on all sides and with an entrance opening 12 facing the hot-air discharge opening 4 and adapted to its dimensions. Entrance opening 12 is surrounded on the side facing outer wall 5 of the airplane by a circumferential sealing lip 13 of an elastic material. Sealing lip 13 lies tightly on the slightly curved outer wall 5 of the airplane and prevents a flowing out of the hot air trapped by collector apparatus 8.

Collector apparatus 8 is supported in a height-adjustable manner on a movable frame 14. The height adjustment is made by an extensible telescopic tube 15.

FIG. 2 shows in a purely exemplary and schematic manner the use of apparatus 7 for deicing an engine intake 16 of an engine 17 located on a wing (not shown) of airplane 2. The hot air exiting from apparatus 7 can be directed in a purposeful manner onto turbine blades 18 of engine 17 which blades are to be deiced, in order to heat turbine blades 18 and melt off a layer of ice located there.

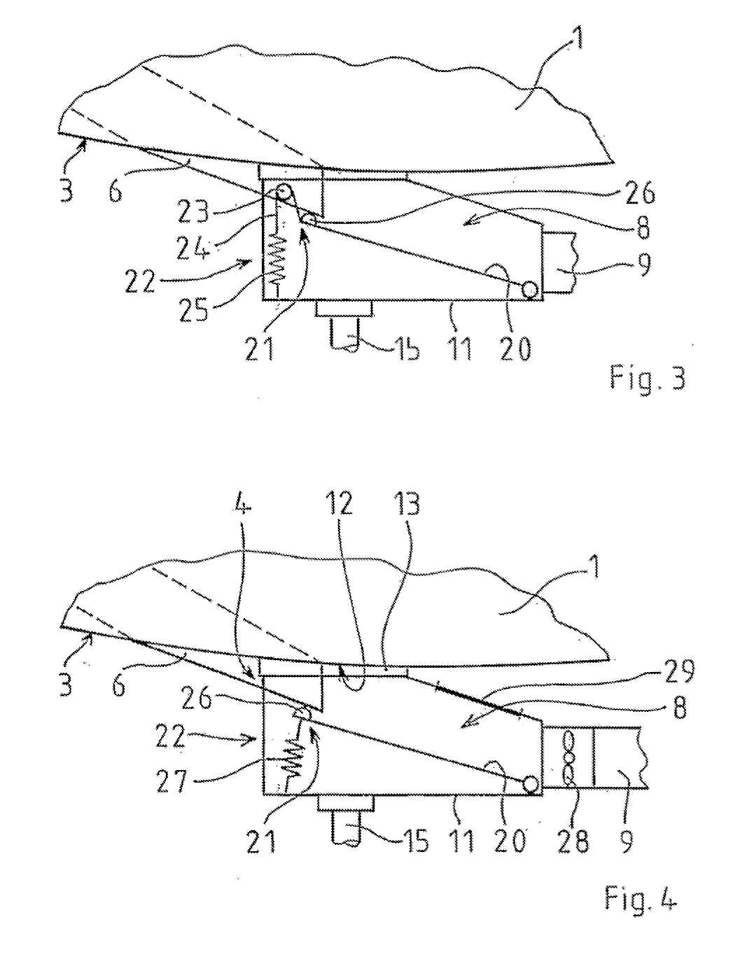

In the exemplary embodiment shown in FIG. 3 housing 11 of collector apparatus 8 comprises a flap 20 pivotably supported in an interior housing space 19. Housing 11 is open on a housing side 22 associated with a pivotable end 21 of flap 20. Pivotably supported flap 20 can be pivoted upward and moved or held in this position or stopped lying closely on the discharge opening flap 6 of hot-air discharge opening 4 of airplane 2. The pivotable end 21 of flap 20 has an operative connection by a cable line 24 with a traction spring 25 in such a manner that the pivotable end 21 of flap 20 is automatically moved closely to discharge opening flap 6 and pressed against it. Another sealing strip 26 of an elastic, sealing material is located on the pivotable end 21 of flap 20.

If discharge opening flap 6 of the hot-air discharge opening 4 is opened further or closed somewhat more by regulating systems located in airplane 2, the pivotably supported flap 20 automatically tracks it in order to ensure at all times a transition which is closed as tight as possible from hot-air discharge opening 4 to collector apparatus 8 of device 7 for deicing airplane 2.

In the exemplary embodiment shown in FIG. 4 the pivotable end 21 of flap 20 is pivoted by a pressure spring 27 in the direction of entrance opening 12 or of hot-air discharge opening 4 and as result also tightly pivoted against the partially open discharge opening 6 and tightly pressed against it. An apparatus for the generation of flow 28 in the form of a ventilator is arranged between collector apparatus 8 and flexible hot-air conduit 9. Collector apparatus 8 has a closable opening 29 through which an admixture of cool ambient air to the current of hot air exiting from deicing nozzle 10 is made possible.

When using a collector apparatus 8 in accordance with the exemplary embodiments described in FIG. 3 or FIG. 4 along with a hot-air discharge opening 4 that closes flush against outer airplane wall 5 and is without a ram-air outlet flap or without discharge opening flap 6, the return force of traction spring 25 or of pressure spring 27 brings it about that the pivotable end 21 of flap 20 rests in a sealing manner on bottom 3 of airplane fuselage 1 and the hot air exiting from hot-air discharge opening 4 can enter through entrance opening 12 into collector apparatus 8. Collector apparatus 8 is consequently equally suitable for hot-air discharge openings 4 with and without discharge opening flap 6 and could be adapted with simple constructive means even to, for example, laterally arranged hot-air discharge openings 4 or to different dimensions and shapes of hot-air discharge openings 4.

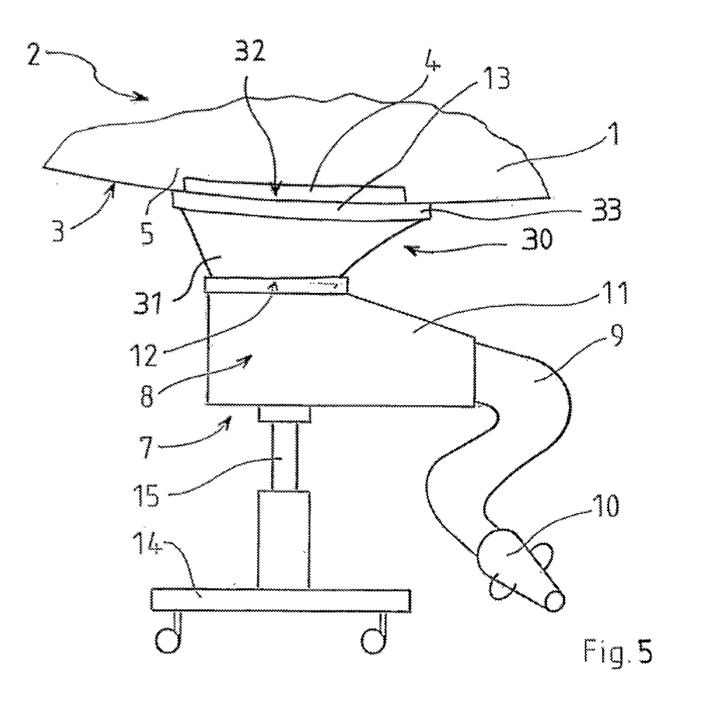

In the exemplary embodiment shown in FIG. 5 an adapter apparatus 30 is set on entrance opening 12 of housing 11 of collector apparatus 8, which opening is located on top, and collector apparatus 8 otherwise coincides with collector apparatus 8 shown in FIGS. 1 and 2. Adapter apparatus 30 comprises a funnel-shaped attachment 31 of sheet metal or of another sufficiently temperature-resistant material. Funnel-shaped attachment 31 is inserted into entrance opening 12 of housing 11 and fixed in this position in a clamping manner, whereby the intrinsic weight of funnel-shaped attachment 31 can reliably prevent an unintended separating of funnel-shaped attachment 31 from housing 11 in most instances.

Additional fastening means or catch elements (not shown) can be provided that make possible in case of need a positive fixing of funnel-shaped attachment 31 to housing 11.

Opening 32 of funnel-shaped attachment 31, which opening faces hot-air discharge opening 4, has a larger cross-sectional surface than entrance opening 12 and is adapted to the correspondingly larger hot-air discharge opening 4 of another airplane type. In order to make possible a sealed transition from hot-air discharge opening 4 into funnel-shaped attachment 31 and into collector apparatus 8, the side of funnel-shaped attachment 31, which side faces outer airplane wall 5, also comprises a circumferential sealing lip 33 of an elastic material.

Collector apparatus 8 can be economically manufactured to a large extent from sheet metal or a sufficiently temperature-resistant plastic. The total weight of apparatus 7 can be as small as possible in order to make possible a simple activation and in particular a simple moving of apparatus 7 to airplane 2 to be deiced and away from it again.

1. A method for the exterior deicing of airplanes before a start, comprising
heating an area of the airplane to be deiced by applying hot air to the area to be deiced, which hot air exits from a deicing nozzle proximate the area to be deiced,
collecting and supplying hot air exiting from a hot-air discharge opening of the airplane is collected and supplied to the deicing nozzle.

2. The method according to claim 1, comprising supplying heated ram air exiting from a ram-air discharge opening to the deicing nozzle (10).

3. The method according to claim 1, comprising varying a temperature of the hot air exiting from the deicing nozzle.

4. The method according to claim 1, comprising varying a flow rate of the hot air on a path to the deicing nozzle.

5. An apparatus for the exterior deicing of airplanes, comprising
a flexible hot-air conduit having a deicing nozzle arranged at a first end of the hot-air conduit,
collector apparatus for hot air exiting from the airplane, which collector apparatus is connected to a second end of the hot-air conduit.

6. The apparatus according to claim 5, wherein the collector apparatus comprises a housing with an entrance opening, the housing surrounding a hot-air exit opening and being fixed on an outer wall of the airplane.

7. The apparatus according to claim 6, wherein the collector apparatus comprises sealing means arranged around the entrance opening on a side facing the outer wall of the airplane.

8. The apparatus according to claim 6, wherein a cross-sectional surface of the entrance opening is variable.

9. The apparatus according to claim 8, wherein an adapter apparatus that changes the cross-sectional surface of the entrance opening is attached to the entrance opening.

10. The apparatus according to claim 9, wherein the adapter apparatus is a funnel-shaped attachment.

11. The apparatus according to claim 9, wherein the adapter apparatus is is connected in a clamping or engaging manner proximate the entrance opening to the housing of the collector apparatus.

12. The apparatus according to claim 8, comprising a pivotable flap adapted to vary a size of the entrance opening.

13. The apparatus according to claim 12, wherein the pivotably supported flap can be moved counter to a return force from a closed position into a partially or completely open position.

14. The apparatus according to claim 5, wherein the collector apparatus or the hot-air conduit comprises closable openings for admixture of cool outside air.

15. The apparatus according to claim 5, wherein the apparatus comprises at least one apparatus for the production of flow.

16. The apparatus according to claim 5, wherein the collector apparatus is supported in a height-adjustable manner on a movable frame.
